(19) United States
(12) Patent Application Publication
(10) Pub. No.: US 2024/0264861 A1
(43) Pub. Date: Aug. 8, 2024

(54) APPARATUS, METHOD, AND SYSTEM FOR SCHEDULING THREADS ON A PROCESSOR

(71) Applicants: Monica GUPTA, Hillsboro, OR (US); Prathviraj BILLAVA, Hillsboro, OR (US); Nachiket PATEL, Hillsboro, OR (US); Russell FENGER, Beaverton, OR (US); Rajshree CHABUKSWAR, Sunnyvale, CA (US); Stephen H. GUNTHER, Beaverton, OR (US); Anusha RAMACHANDRAN, Bangalore (IN)

(72) Inventors: Monica GUPTA, Hillsboro, OR (US); Prathviraj BILLAVA, Hillsboro, OR (US); Nachiket PATEL, Hillsboro, OR (US); Russell FENGER, Beaverton, OR (US); Rajshree CHABUKSWAR, Sunnyvale, CA (US); Stephen H. GUNTHER, Beaverton, OR (US); Anusha RAMACHANDRAN, Bangalore (IN)

(21) Appl. No.: 18/619,507

(22) Filed: Mar. 28, 2024

Related U.S. Application Data
(60) Provisional application No. 63/519,842, filed on Aug. 16, 2023.

(51) Int. Cl. G06F 9/48

(52) U.S. Cl. CPC G06F 9/485; G06F 9/4893

(57) ABSTRACT

An apparatus, computer-implemented method, and system to schedule ready threads on a processor circuitry. T The apparatus includes memory circuitry, machine-readable instructions, and processor circuitry to determine a quality of a first thread of a set of threads that are ready for scheduling on the processor circuitry. Based on the quality of the first thread, the apparatus finds a set of modules of the processor circuitry that are available for scheduling. The apparatus further selects a preferred module of the set of modules for the first thread. The apparatus then schedules the first thread to run on the preferred module.

### CROSS-REFERENCE TO RELATED APPLICATION

This application claims priority to U.S. Provisional Application 63/519,842, filed on Aug. 16, 2023. The content of this earlier filed application is incorporated by reference herein in its entirety.

### BACKGROUND

Modern systems-on-a-chip (SoCs) may have heterogeneous (hybrid) topologies instead of homogeneous ones. Therefore, multiple hardware topological and feedback considerations must be considered when operating systems schedule software threads to achieve optimal performance and energy efficiency. Current operating system software is optimized for homogenous topologies. It must be enhanced for multiple hardware (HW) topology changes (e.g. simultaneous multithreading (SMT), various modules, etc.) and feedback (performance order, energy efficiency order, thread feedback, SMT feedback, etc.).

Therefore, an improved concept for thread scheduling may be desired.

### BRIEF DESCRIPTION OF THE FIGURES

Some examples of apparatuses and/or methods will be described in the following by way of example only, and with reference to the accompanying figures, in which

FIG. 1 shows a block diagram of an example of an apparatus for scheduling threads on a processor;

FIG. 2 shows a flowchart of a method for scheduling threads on a processor;

FIG. 3 shows an example flow diagram for idle processor selection;

FIG. 4 is a block diagram of an electronic apparatus incorporating at least one electronic assembly and/or method described herein;

FIG. 5 illustrates a computing device in accordance with one implementation of the invention; and

FIG. 6 is included to show an example of a higher-level device application for the disclosed embodiments.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, cither temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

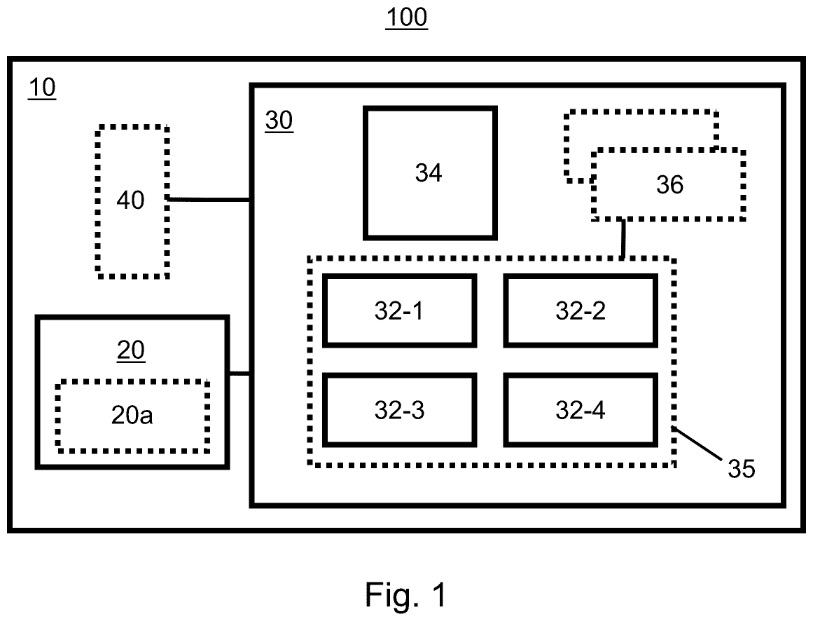

FIG. 1 shows a block diagram of an example of an apparatus 10 or device 10 comprising memory circuitry 20, machine-readable instructions 20a, and processor circuitry 30 to execute the machine-readable instructions. The apparatus 10 determines a quality of a first thread of a set of threads ready for scheduling on the processor circuitry 30. Based on the quality of the first thread, the apparatus 10 finds or identifies a set of modules 35 of the processor circuitry 30 that are available for scheduling. The apparatus 10 further selects a preferred module 32-1 of the set of modules 35 for the first thread. The apparatus 10 then schedules the first thread to run on the preferred module 32-1.

Unlike homogeneous scheduling, which allocates tasks to processors or cores of the same type and capability, heterogeneous scheduling allocates computational tasks across a diverse set of processors, modules, or cores with varying performance characteristics to optimize efficiency and performance. Heterogeneous schedulers may distinguish processors based on the core or module size and policy. This policy may include the foreground status of the thread, its priority, and its expected runtime. On certain platforms, a schedule may also distinguish processors based on the feedback from hardware-guided scheduling (HGS) technology, which informs on performance and energy efficiency capability. However, previous schedulers in a heterogeneous environment might not consider the topology or architecture of a processor.

Topology generally refers to the physical and logical arrangement or configuration of the components within a processor. This may be particularly important when considering systems with a plurality of low-power, compact microprocessors, or modules. For example, in a heterogeneous environment, a processor may consider the availability of multiple modules with the same performance capability. Multiple modules may also have different frequencies or cache topologies. Multiple modules may have the same voltage and frequency curve but access to other locations in memory. All of these aspects may be considered by the apparatuses, methods, and systems discussed and disclosed herein.

Moreover, hardware-guided scheduling module enhancements for various scheduler constructs or optimizations may be important for heterogeneous scheduling.

Conventual scheduler constructs or optimizations, unlike those described in this disclosure, do not consider a heterogeneous platform with different module capabilities, such as priority boosts, thread stealing, thread preemption, fair share scheduling, and thread suspension.

Several ways to optimize heterogeneous scheduling algorithms have been developed based on simultaneous multithreading (SMT) topology and hardware feedback (HGS, SMT, etc.) over various heterogeneous topologies. The example schemes disclosed herein further optimize the heterogenous scheduling algorithm to consider the module topology and the hardware feedback for modules (HGS module enhancements). Examples disclosed herein cover scheduling for multiple module topologies at different performance capabilities. This could be based on differences in process, differences in voltage-frequency curve, max turbo frequency, cache topology, etc.

When multiple modules are in a heterogeneous system, the scheduling algorithm may schedule the ready thread or reschedule the thread at quantum end, etc., on a module that can yield optimal performance or better energy efficiency depending on the thread's or system's needs. In computing, a quantum end may refer to the completion of a predefined time slice or quantum during which a particular process or thread is allowed to run on a CPU. Once this time slice expires, the scheduler may switch to another process or thread to ensure fair CPU time allocation among all processes.

The example schemes disclosed herein address various ways to choose a module from multiple modules in different scheduling scenarios, which could yield better performance or energy efficiency based on system or thread needs. The example schemes disclosed herein describe various operating system (OS) thread scheduling optimizations to support heterogeneous module topology. The example schemes also describe how HGS module enhancements can optimize scheduling to use module resources like cache efficiently. The optimizations are not limited to heterogeneous platforms but can also be applied in multiple module systems that are homogeneous, such as one with only low-power, compact modules.

When the quality of the thread is high, finding the set of modules 35 with the apparatus 10 may include finding at least one of a most performant module and a most efficient module. For high-quality threads, the apparatus 10 identifies the best-suited module for execution from the set of modules 35, prioritizing either performance or efficiency based on the specific requirements of the thread. The apparatus may generally match the quality of the thread to an appropriate quality module or processing environment. This process may ensure that the most capable modules handle the most crucial threads, optimizing for either speed or energy usage as needed, enhancing overall system performance and efficiency.

The quality of the first thread may be determined based on at least one of: a thread priority, a foreground status, and/or an expected runtime. The quality assessment of the first thread may involve evaluating its priority level, whether it's a foreground or background process, and how long it is expected to run. Using one or more of these elements when determining thread quality may allow for a nuanced understanding of each thread's importance and resource requirements, leading to more informed and effective scheduling decisions.

The quality of the first thread may be determined based on information from a hardware feedback module 34 of the processor circuitry 30. The hardware feedback module 34 may provide detailed data about the processor's state and capabilities, which the apparatus 10 uses to evaluate the quality of the first thread. Utilizing real-time hardware feedback for thread assessment ensures that the scheduling decisions are based on the most current and relevant information about the processor's status, thereby optimizing task allocation in a dynamic computing environment.

Current heterogeneous schedulers distinguish processors based on the core size and policy, including a foreground status of the thread, its priority, and its expected runtime. For example, some platforms can distinguish processors based on performance and energy efficiency capability feedback from systems with HGS and those with an advanced processor thread management system (sometimes called HGS+). With that distinction, a heterogeneous scheduler chooses a processor for a ready thread based on the policy. A ready thread may refer to a thread that is prepared to run and waiting in the queue for processor time. This means it has all the necessary resources and is in a state where it can be executed by the CPU as soon as it gets scheduled. In general, current operating system software is optimized only for homogenous topologies.

Considering the module topology for scheduling may benefit the overall system performance, responsiveness, and energy efficiency. For example, when in a heterogeneous system with multiple similar modules, scheduling a new ready thread on a busy module may yield lower system performance compared to scheduling the ready thread on an idle module of the same variety. On the other hand, better energy efficiency can be achieved by scheduling threads on a busy module. When the scheduling algorithm considers the module topology and schedules the thread accordingly, it will be able to meet performance and energy efficiency needs.

These examples, as further explained below, consider various heterogeneous hardware considerations. These include the topology, for example, the availability of multiple modules, in particular multiple modules of the same variety. HGS on multiple modules for various scheduler constructs or optimizations. Thread-specific HGS for modules for various scheduler constructs or optimizations. An HGS module enhancement may be required for various scheduler constructs or optimizations.

For example, scheduling constructs or optimizations in this disclosure may include ready thread selection, idle processor selection, thread preemption, thread stealing, fair share scheduling, and/or thread suspension.

Thread policies, priorities, and runtime may also be used as input to find the processor on a hybrid system with one or more hardware feedback to achieve optimal performance and energy efficiency.

Various phases of the algorithm flow include:

Phase 1: Detect the platform's topology-Hybrid with multiple modules or homogeneous with multiple modules.

Phase 2: Detect various hardware technologies available-Hardware-guided scheduling, hardware-guided scheduling with thread-specific enhancement, hardware-guided scheduling with SMT enhancements, and HGS with module enhancements.

Phase 3: Detect the quality-of-service needs of the thread (is it performance or energy efficiency) based on foreground, runtime of the thread, or thread priority.

Phase 4: Use the algorithm flows described herein to find the optimal scheduling through various scheduling optimizations based on hardware feedback.

Some advantages of the example schemes disclosed can be summarized as follows. The example schemes may enhance the processor usage to its full potential based on performance and energy efficiency needs. The example schemes may improve overall system performance, responsiveness, and energy efficiency by improving optimal module usage in a hybrid environment. Table 1 shows the power benefits observed with the scheduling algorithm in accordance with the examples disclosed herein versus a conventional scheduling algorithm.

TABLE 1

| | 10% | 1.20% | 10% | 13% |
|---|---|---|---|---|
| Power Benefits | TouchXPRT | CrossMark | 7 Zip 2T | 7 Zip 4T |
| Config A | 6.945 | 12.309 | 11.8 | 17.68 |
| 6 core (SMT) + 8 Atom | | | | |
| Scheduling Based | | | | |
| on Disclosure | | | | |
| Config A | 1.168 | 12.471 | 13.2 | 20.34 |
| 6 core (SMT) + 8 Atom | | | | |
| Current Windows | | | | |
| Scheduling | | | | |

Based on the scheduling optimization of the example schemes disclosed herein, the performance was improved by up to 7.5% while running a test with 10 threads on a hybrid system with 8 high-performance cores (p-core) or modules and 2 energy-efficient cores (e-core) or modules. The methodology also provides predictability and consistency in the scheduling behavior compared to current heterogeneous scheduling algorithms.

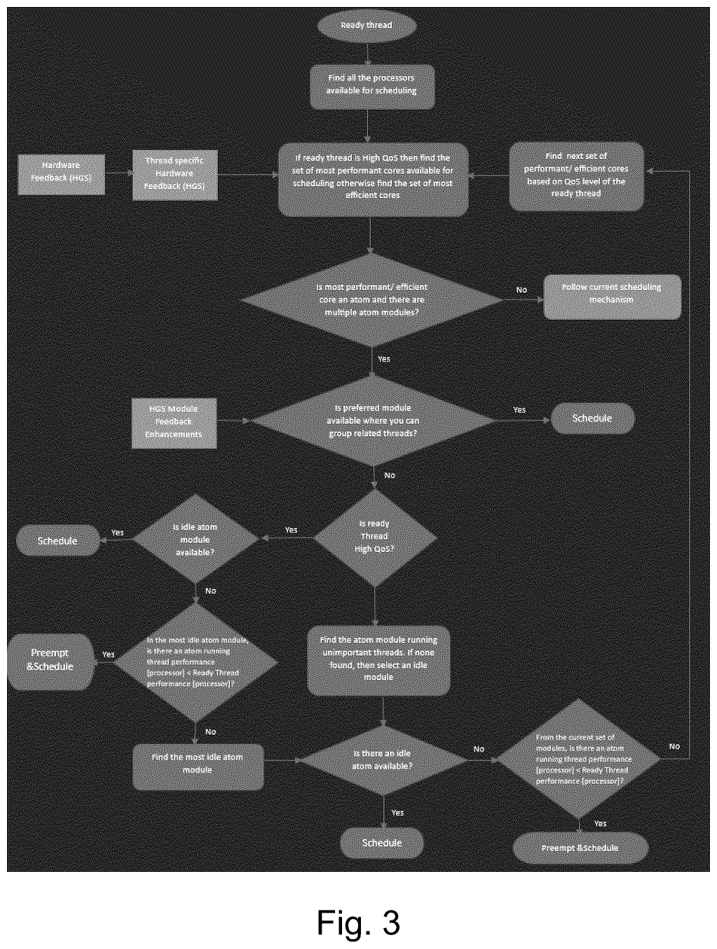

Hereafter, examples will be disclosed for various algorithms for scheduler optimizations/constructs in a novel way to achieve optimal scheduling in a hybrid environment considering the module topology and hardware feedback for modules. It should be noted that the examples disclosed herein, including Tables 2, 3, and 4 and the flow diagram of FIG. 3, may refer to a specific processor or module. However, the reference to a particular type of processor or module is merely an example. The schemes/examples disclosed herein are applicable and can be extended to any processor or module.

Table 2 explains how an idle processor is selected when a thread becomes ready to run or at quantum end. It considers various module topologies. Another consideration is the thread policy based on the thread's priority, foreground, and runtime. The thread policy then decides whether the thread needs to be scheduled for performance or energy efficiency.

TABLE 2

| Hybrid SoC | | Scheduling for Energy |
|---|---|---|
| Topology | Scheduling for Performance | Efficiency |
| 1. Multiple | OS schedules high QoS threads | OS schedules low QoS |
| cores + One | on the best-performing core(s) | threads on best |
| module | as indicated by HGS | efficiency core(s) as |
| topology | | indicated by HGS. |
| 2. Core | If the choice of the idle most | For threads scheduled |
| (with/without | performant processor is a low- | for efficiency (e.g. |
| SMT) + | power core, then select the idle | unimportant |
| Multiple | module. | threads or streaming |
| modules | If none are found, select the | threads), select the |
| with the same | idlest module. | module already running |
| performance | For related threads (e.g. data- | unimportant threads to |
| and | sharing threads), group them on | improve efficiency and |
| efficiency | the same module to reduce | reduce the impact on |
| capabilities | cache access misses/latency. | important threads. |
| 3. Core | If the most performant idle core | If the most |
| (with/without | is a low-power core, then select | efficient core is a |
| SMT) + | the most performant module | low-power module, |
| Multiple | that is completely idle even | then select the |
| modules | if a higher performant | busy module |
| with different | module is active | For unimportant |
| performance | If no idle module is found, then | threads, select the |
| and | select the idlest module | most efficient |
| efficiency | For related threads (e.g. data- | low-power module |
| capabilities | sharing threads), group them on | |
| | the same module to reduce | |
| | cache access misses/latency | |
| 4. HGS | Select the module that provides | Select the module with |
| Module | the highest performance based | the highest energy |
| feedback | on HGS Module feedback. | efficiency based on |
| enhancements | HGS Module feedback can | HGS Module feedback. |
| | provide scheduler information | HGS Module feedback |
| | about opportunities to better use | can provide scheduler |
| | module resources. For example, | information about |
| | if a module is running high | opportunities |
| | cache-intensive | to better use |
| | threads, then the | module resources. For |
| | scheduler can group them with | example, if a module is |
| | less cache-intensive threads to | active or has a lower |
| | reduce the cache access | voltage at the required |
| | misses/latency. | performance level, |
| | | it can provide |
| | | information to the |
| | | scheduler by sending |
| | | higher energy efficiency |
| | | for that module. |

Table 3 explains how the thread-stealing scheduling construct is optimized by considering the module topology and hardware feedback for modules. Thread policy is also used to optimize this scheduling construct.

Thread stealing on a hybrid system helps decide the next thread that can be pulled from other processors and scheduled on a processor going idle for higher performance or energy efficiency.

Thread policy is based on the thread priority, foreground, and runtime of the thread. The thread policy then decides whether the thread needs to be scheduled for performance or energy efficiency.

TABLE 3

| Hybrid SoC | | Scheduling for Energy |
|---|---|---|
| Topology | Scheduling for Performance | Efficiency |
| 1. Multiple | If a more performant processor is | If a more efficient |
| cores + One | going idle, the thread running on | processor is |
| module | the least performant processor is | going idle, the thread |
| topology | pulled over by the | running on the least |
| | more performant | efficient processor |
| | processor. | is pulled over by |
| | In case of multiple | the more efficient |
| | choices, use one | processor. In case |
| | of the importance-deciding | of multiple choices, |
| | matrices to identify finer | use a combination of |
| | granularity in the | performance, thread |
| | thread importance | expected runtime, and |
| | distinction and pull the most | thread importance |
| | important thread. | deciding matrix |
| | | to identify which |
| | | thread to pull. In some |
| | | scenarios, the stealing |
| | | optimization can |
| | | also be avoided; for |
| | | example, short |
| | | threads might |
| | | not be moved |
| | | to avoid the overhead |
| | | of context switching. |
| 2. Core | If a more performant core is going | If a low-power |
| (with/ | idle and the choice to pull thread is | module is |
| without | from one of the cores in multiple | idle and no |
| SMT) + | low-power modules, then an | important thread |
| Multiple | important thread from the most | is available to |
| modules | active low-power module is | steal or pull, |
| with | selected. Threads intentionally | it is more |
| the same | grouped together are exempt from | efficient to keep |
| performance | being pulled. | unimportant |
| and | In the case of multiple choices, use | threads on one |
| efficiency | one of the importance-deciding | low-power |
| capabilities | matrices to identify finer | module from an |
| | granularity in the | efficiency |
| | thread importance | perspective. So, |
| | distinction. | action needs to |
| | If a low-power module is going | be taken. |
| | idle, it pulls the important thread | |
| | from another low-power module | |
| | that is most busy, the exception | |
| | being the threads that are | |
| | intentionally grouped to be able to | |
| | share resources or data. | |
| | Additional thread characteristics, | |
| | like thread runtime, could prevent | |
| | threads from being pulled. For | |
| | example, if the thread runtime is | |
| | short, we want to avoid | |
| | rescheduling it due | |
| | to the overhead | |
| | of rescheduling. | |
| 3. Core | If a more performant core is going | If a more efficient |
| (with/ | idle, and after SMT assessment, the | module is |
| without | choice is to pull from a low-power | going idle and |
| SMT) + | module, and if a more performant | no important |
| Multiple | module is going idle, then pull the | thread is available |
| modules | important threads from the least | to steal or |
| with | performant, most busy low-power | pull, then the |
| different | module. | unimportant |
| performance | If multiple choices are available, | threads running |
| and | use one of the importance-deciding | on the least |
| efficiency | matrices to identify finer | efficient module |
| capabilities | granularity in the thread importance | are pulled |
| | distinction. | over by the |
| | Additional thread characteristics, | more efficient |
| | like thread runtime, could prevent | module going idle. |
| | the thread from being pulled. For | If there are |
| | example, if the thread runtime is | multiple choices, |
| | short and we want to avoid | pick the one |
| | rescheduling it due to the overhead | with more |
| | of rescheduling. In these exception | performance |
| | scenarios, the second best choice is | at the same |
| | looped to identify the optimal | efficiency. |
| | thread to steal. | |
| 4. HGS | If a more performant core is going | If a module is |
| Module | idle, and after SMT assessment, the | going idle |
| feedback | low-power module is the choice, | and no important |
| enhance- | then pull the thread that creates the | thread is |
| ments | least contention on SMT threads of | available to |
| | the core and result in a more | steal or pull, |
| | performant system based on HGS | steal the unimportant |
| | feedback. | threads from the least |
| | If a low-power module is going | efficient module. |
| | idle, then based on HGS module | If there are |
| | feedback, pull the thread that would | multiple choices, |
| | create less contention on the other | pick the one with |
| | low-power module. | more performance |
| | If a low-power module is going | at the same |
| | idle, based on the HGS module | efficiency. |
| | feedback, pull the threads from the | If multiple |
| | busy module to improve the | thread choices |
| | module resource utilization. | and thread |
| | | stealing result in |
| | | a greater number of |
| | | modules being |
| | | active than |
| | | before the stealing |
| | | took place, then |
| | | the thread is |
| | | chosen in such a |
| | | way that it |
| | | creates the least |
| | | contention. |

Table 4 explains how the thread preemption scheduling construct is optimized by considering various module topologies and hardware feedback for modules. Thread policy is also used to optimize this scheduling construct.

Thread preemption on a hybrid system helps decide if a new ready thread selects an idle processor or if it preempts an already running thread on a processor to run on. If no processor is chosen at the end of idle processor selection or thread preemption logic, the ready thready is put back on the ready queue of the most preferred processor.

Thread policy is based on the thread priority, foreground, and runtime of the thread. The thread policy then decides whether the thread needs to be scheduled for performance or energy efficiency.

TABLE 4

| Hybrid SoC | | Scheduling for Energy |
|---|---|---|
| Topology | Scheduling for Performance | Efficiency |
| 1. Multiple | If the most performant core is | If there is no |
| cores + One | not Idle, and a lesser important | idle efficient |
| module | thread (based on QoS, | processor available |
| topology | foreground, priority, and | to schedule |
| | runtime of the thread) is running | based on the idle |
| | on a busy most performant core, | processor selection |
| | then the scheduler preempts the | table above, then |
| | currently running thread to | select the most |
| | schedule the new thread on the | unimportant thread |
| | processor. | (based on runtime |
| | If the most performant processor | and/or priority) |
| | is unavailable, then the next set | |
| | of processors in the performance | |
| | class are evaluated for | |
| | preemption. | |
| 2. Support | After running through the above | If there is no idle efficient |
| for multiple | algorithm, if multiple low-power | processor available to |
| modules: | modules from different modules | schedule based on the idle |
| Core (with | are picked for preemption, then | power processor selection |
| SMT) + | select the low-power module | table above, then |
| Multiple | running the least important | select the most |
| modules | thread. | unimportant thread |
| with the | | (based on runtime and/or |
| same | | priority) |
| performance | | |
| and | | |
| efficiency | | |
| capability | | |
| 3. Core | After running through the above | |
| (with/ | algorithm, if multiple low-power | If there is no idle efficient |
| without | modules from different modules | processor available to |
| SMT) + | are available for preemption, | schedule based on the idle |
| Multiple | then select the module from the | power processor selection |
| modules | most performant low-power | table above, then |
| with | modules. | select the most |
| different | If multiple choices are available, | unimportant thread |
| performance | select the module running the | (based on runtime and/or |
| and | least important thread. | priority) |
| efficiency | | |
| capabilities | | |
| 4. HGS | After running through the above | After running through the |
| Module | algorithm, if multiple low-power | above algorithm, |
| feedback | modules from different modules | if multiple |
| enhance- | are available, select the low- | low-power modules from |
| ments | power module that reduces | different modules are |
| | resource contention the most. | available, then select the |
| | | low-power that reduces |
| | | the contention |
| | | of resources the |
| | | most in the module. |

The preferred module 32-1 may be processing a related thread to the first thread. A preferred module refers to the specific processor unit chosen for task execution. A related thread is another sequence of instructions relevant to or connected to the first thread being processed. It may be a thread from the same application. Grouping related threads allows for efficiency by processing interdependent tasks on the same module, reducing the overhead associated with context switching and improving cache utilization.

The related thread may be determined based on information from a hardware feedback module 34 of the processor circuitry 30. The HGS or hardware feedback module provides real-time data about the processor state, aiding in identifying related threads based on this information. This allows deeper insight into the current threads running on the system.

The set of modules 35 may include a plurality of modules sharing a cache 36 of the processor circuitry 30. Sharing a cache means these units use the same cache memory for storing temporary data. A shared cache among modules can lead to more efficient data access and reduced latency in processing multiple threads.

The set of modules 35 may include a plurality of modules sharing a plurality of caches 36 of the processor circuitry 30. In other words, the plurality of modules sharing the cache comprises a subset sharing one or more further caches 36. Modules may have access to multiple shared caches, with a subset possibly sharing additional caches in a nested structure. A multi-tiered cache-sharing strategy can further enhance data retrieval speeds and processing efficiency, catering to different processing needs.

The preferred module 32-1 may be an idle module. An idle module is a processor unit currently not engaged in task processing. Scheduling tasks on an idle module can lead to quicker task initiation as there's no need to wait for current processes to finish, optimizing overall system responsiveness.

The idle module may be selected based on information from a hardware feedback module 34 of the processor circuitry 30. This selection may be informed by real-time data about the processor's state and capabilities, allowing for a more efficient and intelligent allocation of tasks and ensuring that the most suitable module is chosen for the incoming workload.

The preferred module 32-1 may be processing a lower-quality thread. A lower-quality thread typically refers to a less critical or resource-intensive thread. Prioritizing critical tasks on more capable modules while assigning lower-quality tasks to others can optimize overall system performance and efficiency.

The preferred module may be, in order of preference, processing a related thread to the first thread, idle, or processing a lower-quality thread. This hierarchy establishes a priority order for selecting modules based on the current state and task relationships. This structured approach to task allocation may ensure the most efficient use of the processor's resources, enhancing both task execution efficiency and overall system performance.

The apparatus 10 may further execute the machine-readable instructions 20a for each of a remainder of the set of threads. The apparatus 10 may continue to process the remaining threads in the set beyond the initially selected thread. Generally, the processing order is from the highest to the lowest quality thread. This may ensure comprehensive and systematic processing of all threads in the queue, leading to efficient utilization of computing resources and ensuring that every thread is addressed.

A set of modules 35 of the apparatus 10 may include multiple modules with varying performance and efficiency capabilities. Selecting the preferred module 32-1 may include selecting a most performant idle module when the quality of the first thread indicates that performance is prioritized. The apparatus may differentiate between modules based on their performance capabilities and choose the one with the highest performance that is currently not engaged (idle), particularly when the task at hand requires high performance. This targeted selection process ensures optimal performance for critical or resource-intensive tasks, leading to an efficient and powerful computing experience.

A set of modules 35 of the apparatus 10 may include multiple modules with varying performance and efficiency capabilities. Selecting the preferred module 32-1 may include selecting a module processing a lower-quality thread when the quality of the first thread indicates that energy efficiency is prioritized. In this scenario, the apparatus may reallocate a less critical task (lower-quality thread) from a module to prioritize a more important task that requires less energy, aligning with energy efficiency goals. This strategy may balance performance with energy consumption, reducing the overall energy footprint of the processor while still maintaining effective processing capabilities.

A set of modules 35 of the apparatus 10 may include multiple modules with the same performance and efficiency capabilities. Selecting the preferred module 32-1 may include selecting an idle module based on information from a hardware feedback module of the processor circuitry. Here, the apparatus may select an idle module for task allocation from a group of modules with similar performance characteristics, guided by insights from the hardware feedback module. This may ensure that tasks are evenly distributed among available resources, preventing overuse of any single module, and promoting uniform wear, which can extend the hardware's lifespan.

The apparatus 10 may further monitor the set of modules for an idle module and move the first thread to the idle module when the idle module is more performant or efficient than the preferred module. This functionality may allow the apparatus to continuously observe the state of various modules and dynamically reassign tasks to an idle module if it becomes more suitable than the module currently executing the task. This dynamic reallocation may ensure that the processor is always operating efficiently, adapting to changing conditions and optimizing both performance and energy use.

The set of modules 35 may include multiple modules with varying performance and efficiency capabilities, wherein selecting the preferred module 32-1 comprises selecting a most performant and least busy module when the quality of the ready thread indicates that performance is prioritized. This approach may ensure that the most capable modules handle the most demanding tasks, optimizing for speed and efficiency and improving overall system responsiveness.

The set of modules 35 may include multiple modules with varying performance and efficiency capabilities, wherein selecting the preferred module 32-1 comprises selecting a module processing a lower-quality thread when the quality of the ready thread indicates that energy efficiency is prioritized. This may prioritize energy conservation, delegating less critical tasks to modules already handling low-priority work, thus optimizing power usage without compromising on necessary processing.

The set of modules 35 may include multiple modules with the same performance and efficiency capabilities, wherein selecting the preferred module 32-1 comprises selecting a most performant and least busy module when the quality of the ready thread indicates that performance is prioritized. Choosing the least engaged module that still offers high performance may effectively balance workload distribution, leading to efficient resource use and maintaining consistent performance levels across tasks.

The set of modules 35 may include multiple modules with same performance and efficiency capabilities, wherein selecting the preferred module 32-1 comprises selecting a module processing a lower-quality thread when the quality of the ready thread indicates that energy efficiency is prioritized. This may ensure that tasks requiring less energy consumption are prioritized, promoting an overall energy-efficient operation by carefully assigning tasks based on their intensity and resource needs.

The set of modules 35 may include multiple modules with same performance and efficiency capabilities, wherein selecting the preferred module 32-1 based on information from a hardware feedback module of the processor circuitry. Leveraging real-time hardware data may enable the apparatus to make informed decisions about module selection, ensuring optimal task allocation based on current system conditions and resource availability.

The set of modules 35 may include multiple modules with varying performance and efficiency capabilities, wherein selecting the idlest module based on information from a hardware feedback module of the processor circuitry. This may maximize resource utilization by assigning tasks to modules that are currently least engaged, thus evenly distributing the workload and minimizing idle time for better overall efficiency.

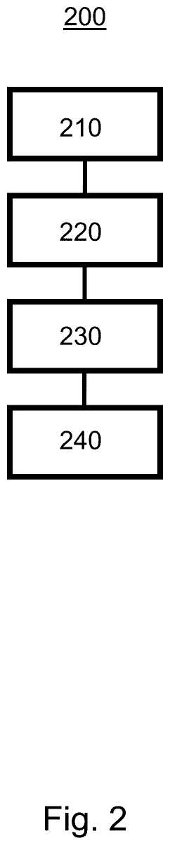

FIG. 1 further shows that the apparatus 10 comprises circuitry to provide the functionality of the apparatus 10. For example, the circuitry of the apparatus 10 may be configured to provide the functionality of the apparatus 10. For example, the apparatus 10 of FIG. 1 includes optional interface circuitry 40, processor circuitry 30, and memory circuitry 20. For example, the processor circuitry 30 may be coupled with the interface circuitry 40 and with the memory circuitry 20. For example, the processor circuitry 30 may provide the functionality of the apparatus, in conjunction with the interface circuitry 40 (for exchanging information, such as with other components inside or outside the computer system 100 comprising the apparatus 10 or device 10), the memory circuitry 20 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or be implemented by, the respective structural components of the apparatus 10. For example, the device 10 of FIG. 1 includes means for processing 30, which may correspond to or be implemented by the processor circuitry 30, means for communicating 40, which may correspond to or be implemented by the interface circuitry 40, (optional) means for storing information 20, which may correspond to or be implemented by the memory circuitry 20. In general, the functionality of the processor circuitry 30 or means for processing 30 may be implemented by the processor circuitry 30 or means for processing 30 executing machine-readable instructions. Accordingly, any feature ascribed to the processor circuitry 30 or means for processing 30 may be defined by one or more instructions of a plurality of machine-readable instructions. The apparatus 10 or device 10 may comprise the machine-readable instructions, e.g. within the memory circuitry 20, a storage circuitry (not shown), or means for storing information 20. For example, the processor circuitry 30 or means for processing 30 may perform a method shown in the present disclosure, such as the method discussed in connection with FIG. 2.

The interface circuitry 40 or means for communicating 40 may correspond to one or more inputs and/or outputs for receiving and/or transmitting information, which may be in digital (bit) values according to a specified code, within a module, between modules or between modules of different entities. For example, the interface circuitry 40 or means for communicating 40 may comprise circuitry configured to receive and/or transmit information.

For example, the processor circuitry 30 or means for processing 30 may be implemented using one or more processing units, one or more processing devices, or any means for processing, such as a processor, a computer, or a programmable hardware component being operable with accordingly adapted software. In other words, the described function of the processor circuitry 30 or means for processing may be implemented in software, which is then executed on one or more programmable hardware components. Such hardware components may comprise a general-purpose processor, a Digital Signal Processor (DSP), a microcontroller, etc.

For example, the memory circuitry 20 or means for storing information 20 may be a volatile memory, e.g. random access memory, such as dynamic random-access memory (DRAM) or static random-access memory (SRAM).

FIG. 1 further shows system 100 comprising processor circuitry 30 processor circuitry with a hardware feedback module 34 and a non-transitory, machine-readable medium 20 storing program code 20a for a thread scheduler. The scheduler determines a quality of a first thread of a set of threads ready for scheduling. The quality is determined based on information from the hardware feedback module 34. Based on the quality of the first thread, the scheduler finds a set of modules 35 of the processor circuitry 30 that are available for scheduling. The scheduler further selects a preferred module 32-1 of the set of modules 35 for the first thread. The preferred module 32-1 may be selected based on information from the hardware feedback module 34. The scheduler then schedules the first thread to run on the preferred module 32-1.

The computer system 100 may be at least one of a client computer system, a server computer system, a rack server, a desktop computer system, a mobile computer system, a security gateway, and a router. The mobile device 100 may be one of a smartphone, tablet computer, wearable device, or mobile computer.

More details and optional aspects of the device of FIG. 2 may be described in connection with examples described above or below (e.g. FIGS. 2-6).

FIG. 2 shows a flowchart of a method 200 or a computer-implemented method to schedule a set of ready threads on a processor circuitry. The method includes determining 210 a quality of a first thread of a set of threads that are ready for scheduling on the processor circuitry. Based on the quality of the first thread, the method 200 finds 220 a set of modules of the processor circuitry that are available for scheduling. The method 200 further selects 230 a preferred module of the set of modules for the first thread. The method 200 then schedules 240 the first thread to run on the preferred module.

Optionally or alternatively, the method 200 may find at least one of a most performant module and a most efficient module when the quality of the thread is high. Optionally or alternatively, the method 200 may comprise selecting the preferred module that is processing a related thread to the first thread, idle when not processing a related thread to the first thread, or processing a lower-quality thread when neither idle nor processing a related thread to the first thread. Optionally or alternatively, the method 200 may repeat the method 200 for each of a remainder of the set of threads.

A non-transitory, machine-readable medium storing program code may, when the program code is executed by processor circuitry, a computer, or a programmable hardware component, cause the processor circuitry, the computer, or the programmable hardware component to perform the method 200.

More details and optional aspects of the device of FIG. 2 may be described in connection with examples described above (e.g. FIG. 1) or below (e.g. FIGS. 3-6).

FIG. 3 shows an example flow diagram for idle processor selection. It provides an overview of how the scheduling logic would perform idle processor selection based on the algorithm described above in a hybrid topology with multiple modules and hardware feedback.

The logic begins with a ready thread and then finds all the processors available for scheduling. If the ready thread is High quality of service (QOS), the logic finds the set of most performant cores available for scheduling. Otherwise, it finds the set of most efficient cores. The logic may use HGS and/or thread-specific HGS to perform this search.

The logic then determines if the most performant or efficient core is a low-power core (e.g. e-core) and if there are multiple modules. If not, a standard scheduling algorithm may be followed. If yes, the logic searches for an available preferred module where related threads can be grouped. The logic may use HGS feedback enhancements to improve this search.

If there are no related threads to group, the logic determines if the ready thread is High QoS. If so, it looks for available idle modules on which to schedule the thread. If one is not available, it checks the idlest module for a thread whose performance is less than that of the ready thread. If one is found, the lower-performing thread is preempted, and the ready thread is scheduled. Otherwise, an idle processor is searched for, and the thread is scheduled there.

If the thread is not High QoS, the logic looks for a module running unimportant threads. If one is found, the unimportant threads are preempted, and the ready thread is scheduled. If none are found, an idle module is searched for. When no ideal module is still found, the logic goes from the current set of modules and determines if there is a module running thread performance of less than the ready thread. If yes, the less performant thread is preempted. If not, the logic finds the next set of performant or efficient cores based on the QoS level of the ready thread and begins the process over again.

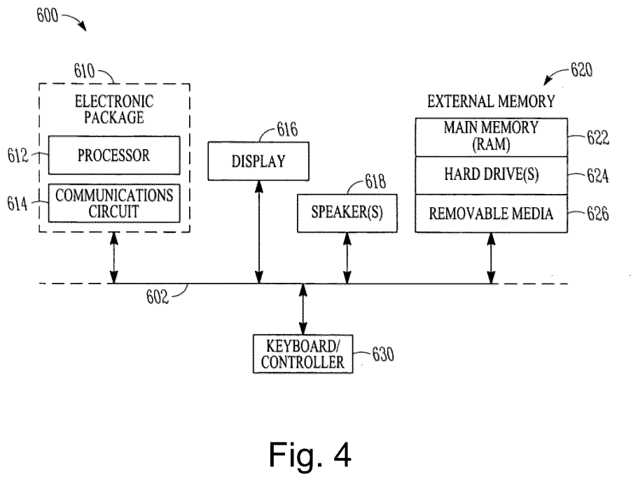

More details and optional aspects of the device of FIG. 3 may be described in connection with examples described above (e.g. FIGS. 1 & 2) or below (e.g. FIGS. 4-6).

FIG. 4 is a block diagram of an electronic apparatus 600 incorporating at least one electronic assembly and/or method described herein. Electronic apparatus 600 is merely one example of an electronic apparatus in which forms of the electronic assemblies and/or methods described herein may be used. Examples of an electronic apparatus 600 include, but are not limited to, personal computers, tablet computers, mobile telephones, game devices, MP3, or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610, as described herein, may be coupled to system bus 602. The electronic assembly 610 may include any circuit or combination of circuits. In one embodiment, the electronic assembly 610 includes a processor 612, which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

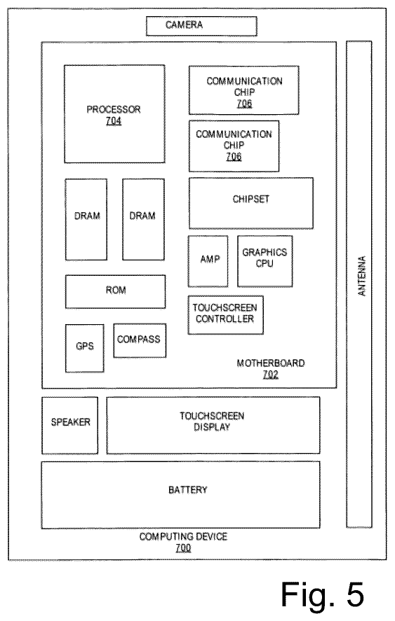

More details and optional aspects of the device of FIG. 4 may be described in connection with examples described above (e.g. FIGS. 1-3) or below (e.g. FIGS. 5 & 6).

FIG. 5 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations, the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g. DRAM), non-volatile memory (e.g. ROM), flash memory, a graphics processor, a digital signal processor, a cryptoprocessor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), etc.). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although, in some embodiments, they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter-range wireless communications such as Wi-Fi and Bluetooth, and a second communication chip 706 may be dedicated to longer-range wireless communications such as GPS, EDGE, GPRS, CDMA, WiMAX, LTE, Ev-DO, and others.

The processor 704 of the computing device 700 includes an integrated circuit die packaged within the processor 704. In some implementations of the invention, the integrated circuit die of the processor includes one or more devices that are assembled in an ePLB or eWLB-based POP package that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or cWLB-based POP package that includes a mold layer directly contacting a substrate, in accordance with implementations of the invention.

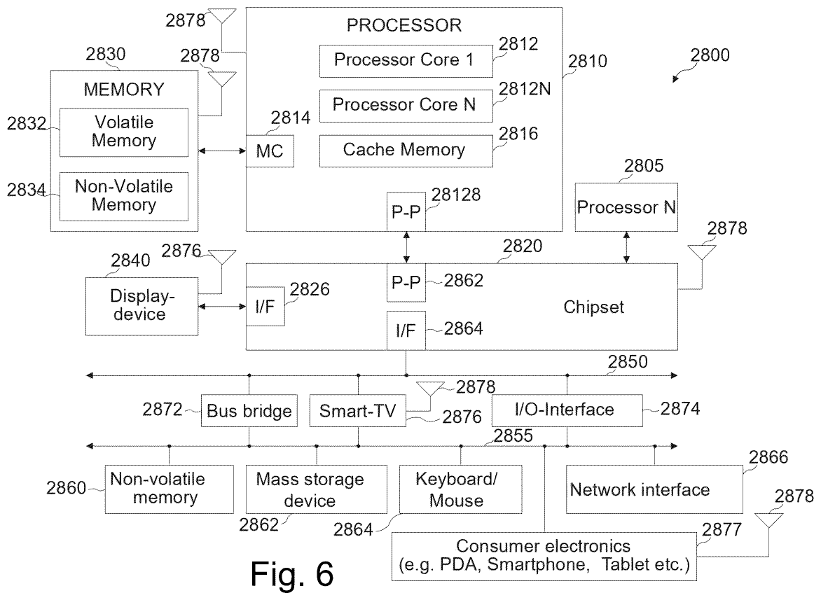

More details and optional aspects of the device of FIG. 5 may be described in connection with examples described above (e.g. FIGS. 1-4) or below (e.g. FIG. 6).

FIG. 6 is included to show an example of a higher-level device application for the disclosed embodiments. The MAA cantilevered heat pipe apparatus embodiments may be found in several parts of a computing system. In an embodiment, the MAA cantilevered heat pipe is part of a communications apparatus that is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to, a laptop computer. In an embodiment, a system 2800 includes, but is not limited to, a netbook. In an embodiment, a system 2800 includes, but is not limited to, a tablet. In an embodiment, a system 2800 includes, but is not limited to, a notebook computer. In an embodiment, a system 2800 includes, but is not limited to, a personal digital assistant (PDA). In an embodiment, a system 2800 includes, but is not limited to, a server. In an embodiment, a system 2800 includes, but is not limited to, a workstation. In an embodiment, a system 2800 includes, but is not limited to, a cellular telephone. In an embodiment, a system 2800 includes, but is not limited to, a mobile computing device. In an embodiment, a system 2800 includes, but is not limited to, a smartphone. In an embodiment, a system 2800 includes, but is not limited to, an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810, where N is a positive integer. In an embodiment, the electronic device system 2800 uses an MAA apparatus embodiment that includes multiple processors, including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions, and the like. In an embodiment, the processor 2810 has a cache memory 2816 to cache at least one of instructions and data for the MAA apparatus in the system 2800. The cache memory 2816 may be organized into a hierarchal structure, including one or more levels of cache memory.

In an embodiment, the processor 2810 includes a memory controller 2814, which is operable to perform functions that enable the processor 2810 to access and communicate with memory 2830, which includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically crasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using an MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, a cathode ray tube (CRT) display, or any other form of visual display device. In an embodiment, the processor 2810 and the chipset 2820 are merged into an MAA apparatus in a system. Additionally, the chipset 2820 connects to one or more buses 2850 and 2855 that interconnect various elements 2874, 2860, 2862, 2864, and 2866. Buses 2850 and 2855 may be interconnected via a bus bridge 2872, such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid-state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 6 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

More details and aspects of the concept for scheduling threads, particularly in heterogeneous systems, are mentioned in connection with the proposed concept or one or more examples described above (e.g. FIGS. 1-6) or below. The concept for scheduling threads may comprise one or more additional optional features corresponding to one or more aspects of the proposed concept or one or more examples described above or below.

More details and aspects of the concept for generating a plurality of shared designs relating to scheduling threads on a processor are mentioned in connection with the proposed concept or one or more examples described above or below. The concept for scheduling threads on a processor may comprise one or more additional optional features corresponding to one or more aspects of the proposed concept or one or more examples described above or below.

An example (e.g. example 1) relates to an apparatus comprising memory circuitry, machine-readable instructions, and processor circuitry to execute the machine-readable instructions to determine a quality of a first thread of a set of threads that are ready for scheduling on the processor circuitry; find, based on the quality of the first thread, a set of modules of the processor circuitry that are available for scheduling; select a preferred module of the set of modules for the first thread; and schedule the first thread to run on the preferred module.

Another example (e.g., example 2) relates to a previously described example (e.g., example 1), wherein finding the set of modules comprises, when the quality of the thread is high, finding at least one of the most performant and a most efficient modules.

Another example (e.g. example 3) relates to a previously described example (e.g. one of the examples 1-2), wherein the preferred module is processing a related thread to the first thread.

Another example (e.g. example 4) relates to a previously described example (e.g. example 3), wherein the related thread is determined based on information from a hardware feedback module of the processor circuitry.

Another example (e.g. example 5) relates to a previously described example (e.g. one of the examples 1-4), wherein the set of modules comprises a plurality of modules sharing a cache of the processor circuitry.

Another example (e.g. example 6) relates to a previously described example (e.g. example 5), wherein the plurality of modules sharing the cache comprise a subset sharing one or more further caches.

Another example (e.g. example 7) relates to a previously described example (e.g. one of the examples 1-6), wherein the preferred module is an idle module.

Another example (e.g. example 8) relates to a previously described example (e.g. example 7), wherein the idle module is selected based on information from a hardware feedback module of the processor circuitry.

Another example (e.g. example 9) relates to a previously described example (e.g. one of the examples 1-8), wherein the preferred module is processing a lower-quality thread.

Another example (e.g. example 10) relates to a previously described example (e.g. one of the examples 1-9), wherein the preferred module is a) processing a related thread to the first thread; b) idle when option a) is unavailable; or c) processing a lower-quality thread when options a) and b) are unavailable.

Another example (e.g. example 11) relates to a previously described example (e.g. one of the examples 1-10), further comprising executing the machine-readable instructions for each of a remainder of the set of threads.

Another example (e.g. example 12) relates to a previously described example (e.g. one of the examples 1-11), wherein the quality of a first thread is determined based on information from a hardware feedback module of the processor circuitry.

Another example (e.g. example 13) relates to a previously described example (e.g. one of the examples 1-12), wherein the quality of the first thread is determined based on at least one of: a thread priority; a foreground status; and an expected runtime.

Another example (e.g. example 14) relates to a previously described example (e.g. one of the examples 1-13), wherein the set of modules includes multiple modules with varying performance and efficiency capabilities, wherein selecting the preferred module comprises selecting a most performant idle module when the quality of the first thread indicates that performance is prioritized.

Another example (e.g. example 15) relates to a previously described example (e.g. one of the examples 1-14), wherein the set of modules includes multiple modules with varying performance and efficiency capabilities, wherein selecting the preferred module comprises selecting a module processing a lower-quality thread when the quality of the first thread indicates that energy efficiency is prioritized.

Another example (e.g. example 16) relates to a previously described example (e.g. one of the examples 1-15), wherein the set of modules includes multiple modules with same performance and efficiency capabilities, and the method includes selecting an idle module based on information from a hardware feedback module of the processor circuitry.

Another example (e.g. example 17) relates to a previously described example (e.g. one of the examples 1-16), further comprising monitoring the set of modules for an idle module and moving the first thread to the idle module when the idle module is more performant or efficient than the preferred module.

Another example (e.g. example 18) relates to a previously described example (e.g. one of the examples 1-17), wherein the set of modules includes multiple modules with varying performance and efficiency capabilities, wherein selecting the preferred module comprises selecting a most performant and least busy module when the quality of the ready thread indicates that performance is prioritized.

Another example (e.g. example 19) relates to a previously described example (e.g. one of the examples 1-18), wherein the set of modules includes multiple modules with varying performance and efficiency capabilities, wherein selecting the preferred module comprises selecting a module processing a lower-quality thread when the quality of the ready thread indicates that energy efficiency is prioritized.

Another example (e.g. example 20) relates to a previously described example (e.g. one of the examples 1-19), wherein the set of modules includes multiple modules with same performance and efficiency capabilities, wherein selecting the preferred module comprises selecting a most performant and least busy module when the quality of the ready thread indicates that performance is prioritized.

Another example (e.g. example 21) relates to a previously described example (e.g. one of the examples 1-19), wherein the set of modules includes multiple modules with same performance and efficiency capabilities, wherein selecting the preferred module comprises selecting a module processing a lower-quality thread when the quality of the ready thread indicates that energy efficiency is prioritized.

Another example (e.g. example 22) relates to a previously described example (e.g. one of the examples 1-21), wherein the set of modules includes multiple modules with same performance and efficiency capabilities, and wherein selecting a most performant module based on information from a hardware feedback module of the processor circuitry.

Another example (e.g. example 23) relates to a previously described example (e.g. one of the examples 1-22), wherein the set of modules includes multiple modules with varying performance and efficiency capabilities, wherein selecting a most idle module based on information from a hardware feedback module of the processor circuitry.

An example (e.g. example 24) relates to method to schedule a set of ready threads on a processor circuitry, the method comprising determining a quality of a first thread of a set of threads that are ready for scheduling on the processor circuitry; finding, based on the quality of the first thread, a set of modules of the processor circuitry that are available for scheduling; selecting a preferred module of the set of modules for the first thread; and scheduling the first thread to run on the preferred module.

Another example (e.g. example 25) relates to a previously described example (e.g. example 24), wherein finding the set of modules comprises, when the quality of the thread is high, finding at least one of a most performant module and a most efficient module.

Another example (e.g. example 26) relates to a previously described example (e.g. one of the examples 24-25), wherein the preferred module is processing a related thread to the first thread.

Another example (e.g. example 27) relates to a previously described example (e.g. example 26), wherein the related thread is determined based on information from a hardware feedback module of the processor circuitry.

Another example (e.g. example 28) relates to a previously described example (e.g. one of the examples 24-27), wherein the set of modules comprises a plurality of modules sharing a cache of the processor circuitry.

Another example (e.g. example 29) relates to a previously described example (e.g. example 28), wherein the plurality of modules sharing the cache comprise a subset sharing one or more further caches.

Another example (e.g. example 30) relates to a previously described example (e.g. one of the examples 24-29), wherein the preferred module is an idle module.

Another example (e.g. example 31) relates to a previously described example (e.g. example 730), wherein the idle module is selected based on information from a hardware feedback module of the processor circuitry.

Another example (e.g. example 32) relates to a previously described example (e.g. one of the examples 24-31), wherein the preferred module is processing a lower-quality thread.

Another example (e.g. example 33) relates to a previously described example (e.g. one of the examples 24-32), wherein the preferred module is a) processing a related thread to the first thread; b) idle when option a) is unavailable; or c) processing a lower-quality thread when options a) and b) are unavailable.

Another example (e.g. example 34) relates to a previously described example (e.g. one of the examples 24-33), further comprising repeating the method for each of a remainder of the set of threads.

Another example (e.g. example 35) relates to a previously described example (e.g. one of the examples 24-34), wherein the quality of a first thread is determined based on information from a hardware feedback module of the processor circuitry.

Another example (e.g. example 36) relates to a previously described example (e.g. one of the examples 24-35), wherein the quality of the first thread is determined based on at least one of a thread priority; a foreground status; and an expected runtime.

Another example (e.g. example 37) relates to a previously described example (e.g. one of the examples 24-36), wherein the set of modules includes multiple modules with varying performance and efficiency capabilities, wherein selecting the preferred module comprises selecting a most performant idle module when the quality of the first thread indicates that performance is prioritized.

Another example (e.g. example 38) relates to a previously described example (e.g. one of the examples 24-37), wherein the set of modules includes multiple modules with varying performance and efficiency capabilities, wherein selecting the preferred module comprises selecting a module processing a lower-quality thread when the quality of the first thread indicates that energy efficiency is prioritized.

Another example (e.g. example 39) relates to a previously described example (e.g. one of the examples 24-38), wherein the set of modules includes multiple modules with same performance and efficiency capabilities, and the method includes selecting an idle module based on information from a hardware feedback module of the processor circuitry.

Another example (e.g. example 40) relates to a previously described example (e.g. one of the examples 24-39), further comprising monitoring the set of modules for an idle module and moving the first thread to the idle module when the idle module is more performant or efficient than the preferred module.

Another example (e.g. example 41) relates to a previously described example (e.g. one of the examples 24-40), wherein the set of modules includes multiple modules with varying performance and efficiency capabilities, wherein selecting the preferred module comprises selecting a most performant and least busy module when the quality of the ready thread indicates that performance is prioritized.

Another example (e.g. example 42) relates to a previously described example (e.g. one of the examples 24-41), wherein the set of modules includes multiple modules with varying performance and efficiency capabilities, wherein selecting the preferred module comprises selecting a module processing a lower-quality thread when the quality of the ready thread indicates that energy efficiency is prioritized.

Another example (e.g. example 43) relates to a previously described example (e.g. one of the examples 24-42), wherein the set of modules includes multiple modules with same performance and efficiency capabilities, wherein selecting the preferred module comprises selecting a most performant and least busy module when the quality of the ready thread indicates that performance is prioritized.

Another example (e.g. example 44) relates to a previously described example (e.g. one of the examples 24-43), wherein the set of modules includes multiple modules with same performance and efficiency capabilities, wherein selecting the preferred module comprises selecting a module processing a lower-quality thread when the quality of the ready thread indicates that energy efficiency is prioritized.

Another example (e.g. example 45) relates to a previously described example (e.g. one of the examples 24-44), wherein the set of modules includes multiple modules with same performance and efficiency capabilities, and the method includes selecting a most module performant based on information from a hardware feedback module of the processor circuitry.

Another example (e.g. example 46) relates to a previously described example (e.g. one of the examples 24-45), wherein the set of modules includes multiple modules with varying performance and efficiency capabilities, and the method includes selecting a most idle module based on information from a hardware feedback module of the processor circuitry.

An example (e.g. example 47) relates to a non-transitory, machine-readable medium storing program code that, when the program code is executed by processor circuitry, a computer, or a programmable hardware component, causes the processor circuitry, the computer, or the programmable hardware component to perform the method of a previously described example (e.g. one of the examples 24-46).

An example (e.g. example 48) relates to a system comprising processor circuitry comprising a hardware feedback module; and a scheduler to determine a quality of a first thread of a set of threads ready for scheduling, wherein the quality of the first thread is determined based on information from the hardware feedback module; find, based on the quality of the first thread, a set of modules of the processor circuitry that are available for scheduling; select a preferred module of the set of modules for the first thread, wherein the preferred module is selected based on information from the hardware feedback module; and schedule the first thread to run on the preferred module.

Another example (e.g. example 49) relates to a previously described example (e.g. example 48), wherein the system is configured to perform a method of a previously described example (e.g. one of the examples 24-46).

An example (e.g. example 50) is a system comprising an apparatus, computer-readable medium, or circuitry for performing a method of a previously described example (e.g. one of the examples 24-46).

The aspects and features described in relation to a particular one of the previous examples may also be combined with one or more of the further examples to replace an identical or similar feature of that further example or to additionally introduce the features into the further example.

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g. machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g. via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. An apparatus comprising memory circuitry, machine-readable instructions, and processor circuitry to execute the machine-readable instructions to:
determine a quality of a first thread of a set of threads that are ready for scheduling on the processor circuitry;
find, based on the quality of the first thread, a set of modules of the processor circuitry that are available for scheduling;
select a preferred module of the set of modules for the first thread; and
schedule the first thread to run on the preferred module.

2. The apparatus of claim 1, wherein finding the set of modules comprises, when the quality of the thread is high, finding at least one of:
a most performant module; and
a most efficient module.

3. The apparatus of claim 1, wherein the preferred module is processing a related thread to the first thread.

4. The apparatus of claim 3, wherein the related thread is determined based on information from a hardware feedback module of the processor circuitry.

5. The apparatus of claim 1, wherein the set of modules comprises a plurality of modules sharing a cache of the processor circuitry.

6. The apparatus of claim 5, wherein the plurality of modules sharing the cache comprise a subset sharing one or more further caches.

7. The apparatus of claim 1, wherein the preferred module is an idle module.

8. The apparatus of claim 7, wherein the idle module is selected based on information from a hardware feedback module of the processor circuitry.

9. The apparatus of claim 1, wherein the preferred module is processing a lower-quality thread.

10. The apparatus of claim 1, wherein the preferred module is:
a) processing a related thread to the first thread;
b) idle when option a) is unavailable; or
c) processing a lower-quality thread when options a) and b) are unavailable.

11. The apparatus of claim 1, further comprising executing the machine readable instructions for each of a remainder of the set of threads.

12. The apparatus of claim 1, wherein the quality of a first thread is determined based on information from a hardware feedback module of the processor circuitry.

13. The apparatus of claim 1, wherein the quality of the first thread is determined based on at least one of:
a thread priority;
a foreground status; and
an expected runtime.

14. The apparatus of claim 1, wherein the set of modules includes multiple modules with varying performance and efficiency capabilities, wherein selecting the preferred module comprises selecting a most performant idle module when the quality of the first thread indicates that performance is prioritized.

15. The apparatus of claim 1, wherein the set of modules includes multiple modules with varying performance and efficiency capabilities, wherein selecting the preferred module comprises selecting a module processing a lower-quality thread when the quality of the first thread indicates that energy efficiency is prioritized.

16. The apparatus of claim 1, wherein the set of modules includes multiple modules with same performance and efficiency capabilities, wherein selecting an idle module based on information from a hardware feedback module of the processor circuitry.

17. The apparatus of claim 1, further comprising monitoring the set of modules for an idle module and moving the first thread to the idle module when the idle module is more performant or efficient than the preferred module.

18. A method to schedule a set of ready threads on a processor circuitry, the method comprising:
determining a quality of a first thread of a set of threads that are ready for scheduling on the processor circuitry;
finding, based on the quality of the first thread, a set of modules of the processor circuitry that are available for scheduling;
selecting a preferred module of the set of modules for the first thread; and
scheduling the first thread to run on the preferred module.

19. A non-transitory, machine-readable medium storing program code that, when the program code is executed by processor circuitry, a computer, or a programmable hardware component, causes the processor circuitry, the computer, or the programmable hardware component to perform the method of claim 18.

20. A system comprising:
processor circuitry comprising a hardware feedback module; and
a scheduler to:
determine a quality of a first thread of a set of threads ready for scheduling, wherein the quality of the first thread is determined based on information from the hardware feedback module;
find, based on the quality of the first thread, a set of modules of the processor circuitry that are available for scheduling;
select a preferred module of the set of modules for the first thread, wherein the preferred module is selected based on information from the hardware feedback module; and
schedule the first thread to run on the preferred module.
